(19) United States
(12) Patent Application Publication
(10) Pub. No.: US 2012/0278121 A1
(43) Pub. Date: Nov. 1, 2012

(54) COMPUTER CONFIGURED RESOURCE MANAGEMENT MODEL

(75) Inventors: Kendall S. Bateman, Bellevue, WA (US); Emily Crow, Charlotte, NC (US); Matthew C. Miller, Fort Mill, SC (US)

(73) Assignee: BANK OF AMERICA CORPORATION, Charlotte, NC (US)

(21) Appl. No.: 13/097,110

(22) Filed: Apr. 29, 2011

(51) Int. Cl. G06Q 10/00

(52) U.S. Cl. 705/7.22; 705/7.12

(57) ABSTRACT

A computer configured method, apparatus, computer readable medium and system are disclosed for allocating one or more resources. In some embodiments, the one or more resources may be associated with one or more properties. A computer may obtain characteristics associated with the properties. The obtained characteristics may include area occupied by the properties, counts of types of properties, and a status of third party use of the properties. In some embodiments, the computer may group properties sharing a common characteristic, and then compute values associated with the characteristic using one or more algorithms. The computer may transform the computed values via one or more respective parameters representative of a unit measure of the resource in order to obtain a number of units of the resource needed for each grouping. The number of units of the resource needed for each grouping may then be examined by the computer to obtain a (total) resource allocation.

### FIELD

Aspects of the present disclosure relate to special purpose computers and systems. More specifically, aspects of this disclosure relate to computers adapted to perform property resource management.

### BACKGROUND

Improvements in computing technologies have changed the way people interact with one another, as well as how people manage and conduct business. For example, representatives or management may staff a business by entering a schedule into one or more computers. The employees or staff of the business may receive a copy of the schedule via a text message, an email, or the like, and may show up to work at their allotted time.

Traditional modeling techniques for determining how many employees to staff at a given time have simply used number of properties, or a related metric of area or space (frequently measured in terms of square feet), for purposes of allocating resources. For example, a business may formulate a staffing or employee model based on the number of locations the business needs to service and how large the (collective) locations are.

Such gross formulations tend to misallocate resources. For example, in the context of staffing, too few or too many employees or workers may be assigned to a given area or task if the model is not optimized.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to an apparatus, method and system for managing one or more resources. In some embodiments, the one or more resources may include human personnel, e.g., staff, employees, workers, or the like.

In some embodiments, the one or more resources may be managed based on a number of factors or criteria associated with one or more properties. In some embodiments, a determination may be made whether a property is a critical facility (tier 1-4) or non-tiered (e.g., tier zero). In some embodiments, a determination may be made whether a (non-tiered) property is owned or triple net (net-net-net or NNN) leased. In some embodiments, a determination may be made whether a (non-tiered) property is the subject of a gross lease. In some embodiments, a determination may be made whether a property is a retail building or a small building. In some embodiments, a determination may be made whether one or more third party tenants are associated with (e.g., leasing) a property. The sizes of the property/properties may also be taken into consideration in some embodiments.

In some embodiments, based on an identification of properties or characteristics associated with one or more properties or locations, a staffing model may be established or generated. In some embodiments, a staffing model may generate values indicative of an optimal number of employees or workers that should be staffed at one or more of the properties or locations.

These and other illustrative embodiments are described herein.

### BRIEF DESCRIPTION OF THE DRAWINGS

The present disclosure is illustrated by way of example and not limited in the accompanying figures in which like reference numerals indicate similar elements.

FIG. 1 illustrates an example of an operating environment in which various aspects of the disclosure may be implemented.

FIG. 2 illustrates a simplified diagram of a computing device in which various aspects of the disclosure may be implemented.

FIG. 3 illustrates a method suitable for implementing one or more aspects of this disclosure.

### DETAILED DESCRIPTION

In the following description of the various embodiments, reference is made to the accompanying drawings, which form a part hereof, and in which is shown by way of illustration various embodiments in which one or more aspects of the disclosure may be practiced. It is to be understood that other embodiments may be utilized and structural and functional modifications may be made without departing from the scope of the present disclosure.

Various connections between elements are discussed in the following description. These connections are general and, unless specified otherwise, may be direct or indirect, wired or wireless, and this specification is not intended to be limiting in this respect.

In accordance with various aspects of this disclosure, apparatuses, systems and methods are described for providing a resource allocation model. For illustrative purposes the resource allocation discussed throughout the below description relates to staffing. However, as those skilled in the art will realize upon a review of this disclosure, the described aspects of the disclosure are not limited to staffing, but may also include other types of allocation models, such as tool set allocations, credit or finance allocations, etc.

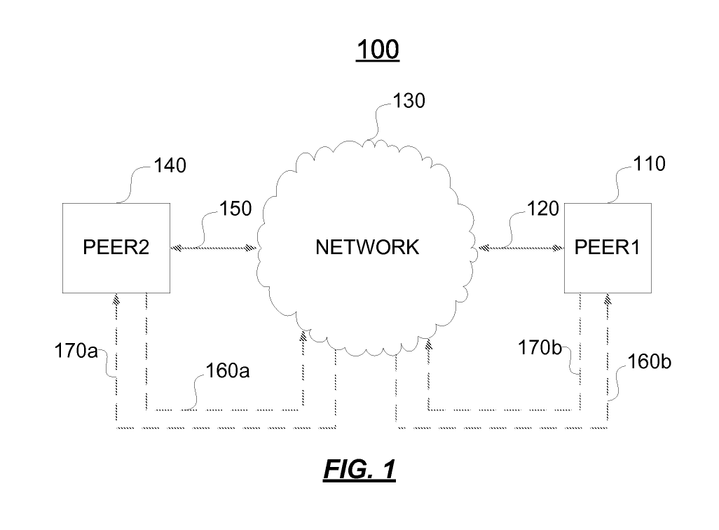

FIG. 1 illustrates a network computing environment 100 suitable for carrying out one or more aspects of this disclosure. For example, FIG. 1 illustrates a first peer device PEER1 110 connected to a network 130 via a connection 120. Network 130 may include the Internet, an intranet, wired or wireless networks, or any other mechanism suitable for facilitating communication between computing platforms in general. FIG. 1 also depicts a second peer device PEER2 140 connected to network 130 via a connection 150. By virtue of the connectivity as shown, PEER1 110 and PEER2 140 may communicate with one another. Such communications may enable the exchange of various types of information. For example, the communications may include data to be exchanged between PEER1 110 and PEER2 140. Such data may include structures, files, and the like. The communications may further include additional information such as control information.

Connections 120 and 150 illustrate interconnections for communication purposes. The actual connections represented by connections 120 and 150 may be embodied in various forms. For example, connections 120 and 150 may be hardwired/wireline connections. Alternatively, connections 120 and 150 may be wireless connections. Connections 120 and 150 are shown in FIG. 1 as supporting bi-directional communications (via the dual arrow heads on each of connections 120 and 150). Alternatively, or additionally, computing environment 100 may be structured to support separate forward (160a and 160b) and reverse (170a and 170b) channel connections to facilitate the communication.

Computing environment 100 may be carried out as part of a larger network consisting of more than two devices. For example, PEER2 140 may exchange communications with a plurality of other devices (not shown) in addition to PEER1 110, such as a server computer. The communications may be conducted using one or more communication protocols. Furthermore, computing environment 100 may include one or more intermediary nodes (not shown) that may buffer, store, or route communications between the various peer devices.

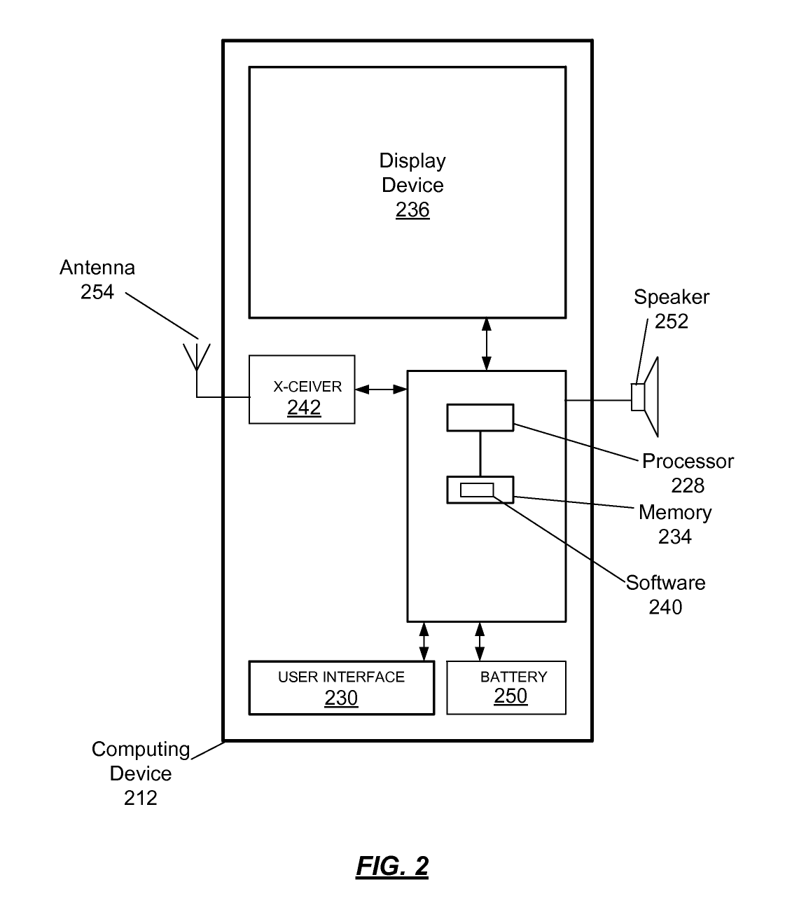

FIG. 2 illustrates a computing device 212, e.g., a desktop computer, laptop computer, notebook computer, network server, portable computing device, personal digital assistant, smart phone, mobile telephone, cellular telephone (cell phone), terminal, distributed computing network device, or any other device having the requisite components or abilities to operate as described herein. In some embodiments, one or more components associated with computing device 212 may be resident in the computing devices (e.g., devices 110 and 140) of FIG. 1.

As shown in FIG. 2, device 212 may include a processor 228 connected to a user interface 230, memory 234 and/or other storage, and display device 236. Device 212 may also include battery 250 (or other power source or connection), speaker 252 and antenna(s) 254. User interface 230 may further include a keypad, touch screen, voice interface, four arrow keys, joy-stick, stylus, data glove, mouse, roller ball, touch screen, or the like. In addition, user interface 230 may include the entirety of or portion of display device 236. Computer executable instructions and data used by processor 228 and other components within device 212 may be stored in a computer readable memory 234. The memory may be implemented with any combination of read only memory modules or random access memory modules, optionally including both volatile and nonvolatile memory. Software 240 may be stored within memory 234 and/or storage to provide instructions to processor 228 for enabling device 212 to perform various functions. Alternatively, some or all of the computer executable instructions may be embodied in hardware or firmware (not shown). Furthermore, the computing device 212 may include additional hardware, software and/or firmware to support one or more aspects of the invention as described herein.

Device 212 may be configured with a transceiver 242 to transmit/receive, encode/decode and process data or information. In some embodiments, the communications may be based on one or more communication protocols or standards.

In some embodiments, computer program product implementations may be used and may include a series of computer instructions fixed either on a tangible medium, such as a computer readable medium (e.g., a diskette, CD-ROM, ROM, DVD, fixed disk, etc.) or transmittable to computer device 212, via a modem or other interface device, such as a communications adapter connected to a network over a medium, which is either tangible (e.g., optical or analog communication lines) or implemented wirelessly (e.g., microwave, infrared, or other transmission techniques). In some embodiments, one or more transitory and/or non-transitory computer readable media may be used. The series of computer instructions may embody all or part of the functionality with respect to the computer system, and can be written in a number of programming languages for use with many different computer architectures and/or operating systems, as would be readily appreciated by one of ordinary skill. The computer instructions may be stored in any memory device (e.g., memory 234), such as a semiconductor, magnetic, optical, or other memory device, and may be transmitted using any communications technology, such as optical infrared, microwave, or other transmission technology. Such a computer program product may be distributed as a removable medium with accompanying printed or electronic documentation (e.g., shrink wrapped software), preloaded with a computer system (e.g., on system ROM or fixed disk), or distributed from a server or electronic bulletin board over a network (e.g., the Internet or World Wide Web). Various embodiments of the invention may also be implemented as hardware, firmware or any combination of software (e.g., a computer program product), hardware and firmware. Moreover, the functionality as depicted may be located on a single physical computing entity, or may be distributed between multiple computing entities.

By way of introduction, aspects of this disclosure may provide for allocating human personnel, e.g., staff, amongst a number of properties or locations. For example, models may be constructed and executed to support determining how many workers or employees to staff at a given location or property. In some embodiments, characteristics of the property may factor into or influence the model.

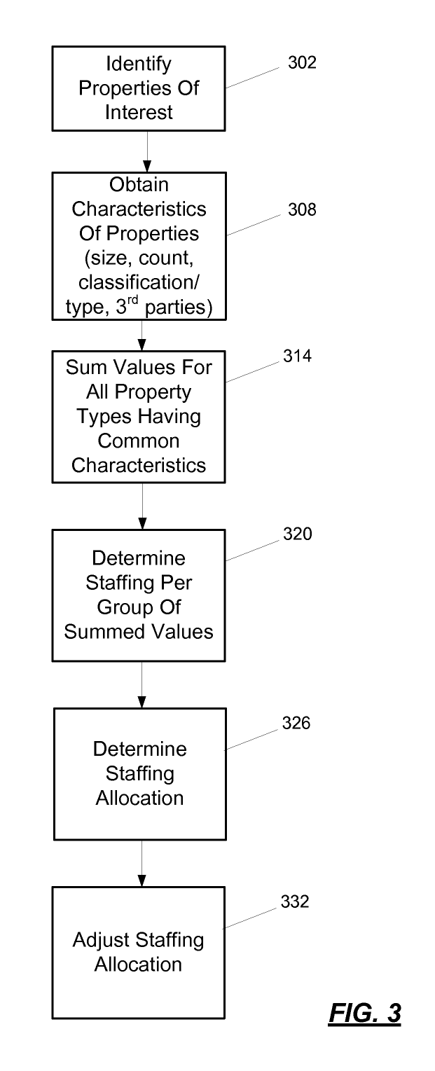

FIG. 3 illustrates a method that may be used to illustrate one or more aspects of this disclosure. The method of FIG. 3 may be operative in one or more environments and/or on one or more computing devices (e.g., the environments and architectures shown in FIGS. 1-2).

In step 302, one or more properties or locations associated with a business may be identified. For example, in a banking context, an identification of such properties may include identifying a bank's headquarters, regional offices, mailing/distribution centers, local branches, etc. Dependent on the level of perspective available or desired, a user may filter the identified locations to obtain locations of interest. For example, a regional manager of the bank might only be interested in those properties that the regional manager is responsible for. Thus, the regional manager might only be interested in his regional office and any local branches falling within his jurisdiction or area of supervision.

Once the properties of interest are identified in connection with step 302, characteristics associated with the properties may be obtained in step 308. In some embodiments, those characteristics may include a size of the properties, a count of the properties, etc. In some embodiments, the properties may be measured in terms of area (e.g., square footage), although any (absolute or relative) scale of measurement of any kind or type may be used.

In some embodiments, the obtained characteristics associated with step 308 may include a classification of the property in terms of type. For example, in some embodiments, a property may be classified as a critical facility (tier 1-4) or a non-tiered (e.g., tier 0) facility. In some embodiments, non-tiered facilities may be further (sub)classified as one of: (1) non-tiered owned or triple net (net-net-net or NNN) leased, (2) non-tiered gross leased, or (3) a retail or small building. These terms are known to those of ordinary skill in the art, and thus, a further elaboration as to their meanings is not included in the instant disclosure.

In some embodiments, the obtained characteristics associated with step 308 may include an identification of whether, and to what extent, one or more third parties occupy the identified properties. The presence of third parties may be signified in terms of area (e.g., square footage) occupied, count or number of third parties present, etc.

Table 1 shown below illustrates property classifications that may be used. In some embodiments, the classifications associated with line numbers 1-4 may be mutually exclusive and collectively exhaustive (e.g., a given property or location might need to be assigned to one, and only one, of lines #1-4). In some embodiments, third party effects associated with line numbers 5-6 may be additive to the classifications associated with line numbers 1-4, when the conditions associated with line numbers 5-6 apply. Thus, a property that is both a central facility and has a third party present in (or at) it may have corresponding contributions towards a staffing allocation as further described below.

TABLE 1
PROPERTY CLASSIFICATIONS

| Line Number (#) | Property Type |
|---|---|
| 1 | Critical Facilities (Tier 1-4) |
| 2 | Non-tiered Owned Or NNN Leased |
| 3 | Non-tiered Gross Leased |
| 4 | Retail And Small Building |
| 5 | Third Party Tenant Square Feet |
| 6 | Number Of Third Party Tenants |

Referring back to FIG. 3, in step 314 the values for all the property types having a common characteristic/classification may be summed. Referring to line numbers 1-4 of Table 1, for properties that are characterized as being critical facilities, the square footage for those critical facilities may be summed. Thus, if two properties are identified as being critical facilities, and a first of the critical facilities is 400,000 square feet and a second of the critical facilities is 500,000 square feet, then the total area that is characterized as encompassing a critical facility is 900,000 (400,000+500,000) square feet. Similar summations may take place with respect to properties characterized as non-tiered owned or NNN leased (line #2 of Table 1), non-tiered gross leased (line #3 of Table 1), and retail and small building (line #4 of Table 1). It is noted that the retail and small building classification (line #4) in Table 1 is based on counts, rather than area (e.g., square footage). Continuing this example, three properties may be identified as being non-tiered owned or NNN leased having a total area of 240,000 square feet, ten properties may be identified as being non-tiered gross leased having a total area of 2,000,000 square feet, and two-hundred fifty properties may be identified as being a retail or small building. Table 2 shown below represents a summation of the characteristics for line #'s 1-4 provided in the example described above.

TABLE 2
Summed Values For Property Classifications, Lines 1-4

| Line Number (#) | Property Type | Summed Value |
|---|---|---|
| 1 | Critical Facilities (Tier 1-4) | 900,000 sq. ft. |
| 2 | Non-tiered Owned Or NNN Leased | 240,000 sq. ft. |
| 3 | Non-tiered Gross Leased | 2,000,000 sq. ft. |
| 4 | Retail And Small Building | 250 count |
| 5 | Third Party Tenant Square Feet | |
| 6 | Number Of Third Party Tenants | |

Referring back to FIG. 3, step 314 may also include summing third party effects or impact on the properties. Referring to Tables 1 and 2 above, the total area occupied by third party tenants (line #5) and the number of third party tenants (line #6) may be summed, respectively. Continuing the above example, the obtained characteristics may indicate that a total count of three-hundred third party tenants occupy a total of 1,100,000 square feet in the properties of interest. These illustrative values are shown in the third column of Table 3 below (lines #5-6), with the values for lines #1-4 from Table 2 having been carried over into Table 3.

TABLE 3
Summed Values For Property Classifications, Lines 1-6

| Line Number (#) | Property Type | Summed Value |
|---|---|---|
| 1 | Critical Facilities (Tier 1-4) | 900,000 sq. ft. |
| 2 | Non-tiered Owned Or NNN Leased | 240,000 sq. ft. |
| 3 | Non-tiered Gross Leased | 2,000,000 sq. ft. |
| 4 | Retail And Small Building | 250 count |
| 5 | Third Party Tenant Square Feet | 1,100,000 sq. ft. |
| 6 | Number Of Third Party Tenants | 300 count |

Referring back to FIG. 3, in step 320 a staffing allocation per group or line number of summed values may be determined. A parameter of one (1) full time employee (FTE) per group or line number may be established to facilitate the calculation of the staffing allocation. For example, referring to Table 4 below, a parameter of “one full time employee (FTE) per” as shown in the fourth column may be established. Thus, as shown in line #1, one full time employee may be desired for every 300,000 square feet of critical facilities. Values for lines #2-6 may be established for the “one full time employee (FTE) per” parameter as shown in the fourth column of Table 4.

Dividing the values in the summed value column (the third column) by the “one full time employee (FTE) per” value (the fourth column) for each respective line number may be used to generate an “FTE allocation” per line number as shown in the fifth column of Table 4. In other words, in some embodiments, the FTE allocation=summed value/FTE per. Thus, for line #1, the total area of 900,000 square feet of critical facilities divided by 300,000 square feet per FTE equals an allocation of three FTEs. Similar remarks apply with respect to the calculations for lines #2-6 (e.g., dividing the third column value by the fourth column value to obtain an FTE allocation in the fifth column for each line number).

TABLE 4
Staffing Allocation Per Group Of Summed Values

| Line | | | | |
|---|---|---|---|---|
| Number | Property | | | FTE |
| (#) | Type | Summed Value | 1 FTE per | Allocation |
| 1 | Critical | 900,000 sq. ft. | 300,000 sq. ft. | 3 |
| | Facilities | | | |
| | (Tier 1-4) | | | |
| 2 | Non-tiered | 240,000 sq. ft. | 650,000 sq. ft. | 0.37 |
| | Owned Or | | | |
| | NNN Leased | | | |
| 3 | Non-tiered | 2,000,000 sq. ft. | 1,500,000 sq. ft. | 1.33 |
| | Gross | | | |
| | Leased | | | |
| 4 | Retail And | 250 count | 100 count | 2.50 |
| | Small | | | |
| | Building | | | |
| 5 | Third Party | 1,100,000 sq. ft. | 750,000 sq. ft. | 1.47 |
| | Tenant | | | |
| | Square Feet | | | |
| 6 | Number Of | 300 count | 75 count | 4 |
| | Third Party | | | |
| | Tenants | | | |

Referring back to FIG. 3, in step 326 a staffing determination may be made. The staffing determination may be based on the values computed in connection with step 320. For example, and referring to Table 4 above, summing the FTE allocations per line number (3+0.37+1.33+2.50+1.47+4) may provide a staffing value of 12.67 FTEs.

Different techniques may be used to determine what to do when the generated value associated with step 326 is not a whole number. Rounding techniques (e.g., rounding to the nearest whole number, rounding up, rounding down) may be used in some embodiments. Thus, referring to the above example of 12.67 FTEs having been calculated, in some embodiments 12 or 13 FTEs may be allocated based on the rounding used. In some embodiments, FTEs may be combined with temporary employees or workers to address differences. Thus, continuing the above example where the computations resulted in 12.67 FTEs, 12 FTEs may be allocated and a temporary employee may be allocated two out of every three (e.g., ⅔=0.67) days, weeks, months, etc., to address any shortage in output that may result from only having allocated 12 FTEs. In some embodiments, one or more computing devices may present both rounded up and rounded down values (e.g., 12 or 13 FTEs in this example) as an option to a user, and the user may make a selection as to which of the values to use. Responsive to receiving the user selection, the computing device(s) may allocate or de-allocate the temporary employee, accordingly.

In step 332, adjustments may be made to the staffing allocation. For example, a business that is formulating a staffing allocation may know of particular needs that need to be addressed that are not reflected in the model or calculations. Thus, the business may make adjustments to the computed values to take into account such considerations. In some embodiments, an additional four FTEs may be allocated above what is determined by the model calculations.

The method, the tables, and the values described above in connection with FIG. 3 are illustrative. Different values may be used in some embodiments. In some embodiments, one or more of the steps (or portions thereof) of the method may execute in an order different from that shown. In some embodiments, one or more of the steps may be optional. In some embodiments, one or more steps not shown may be included. In some embodiments, rather than grouping properties based on one or more common characteristics and then computing an FTE based on the groupings as described above, each property may be examined and a corresponding FTE calculated for that property in turn (e.g., as part of a larger loop). Such an approach may tend to be more expensive or complex from a computational or processing perspective, but may provide insight into the specific staffing requirements associated with each particular location.

As described above, one or more of the steps described above in connection with FIG. 3 may execute on one or more computing architectures, environments, or devices. For example, the input information (e.g., the identity and characteristics/classifications of the various properties) may be stored at one or more servers or databases. The one or more servers or databases may also store the “one full time employee (FTE) per” parameter described above. In some embodiments, the one or more servers or databases may perform the calculations (e.g., steps 320 and 326) to determine a staffing allocation, and the result(s) of those calculations (e.g., the calculated staffing allocations) may be transmitted to one or more user or client computers. In some embodiments, one or more of the computations or calculations may take place at the user or client computers. In those embodiments, the input information and/or the “one full time employee (FTE) per” parameter described above may also be stored at, or transmitted or provided to the user or client computers to facilitate such computations.

Aspects of this disclosure may readily be applied to, and adapted to be operative on, one or more communication systems. Those communication systems may include computer networks, television networks, satellite networks, telephone and cellular networks, and the like.

Although not required, various aspects described herein may be embodied as a method, a data processing system, and/or as one or more transitory and/or non-transitory computer readable media storing executable instructions. Accordingly, those aspects may take the form of an entirely hardware embodiment, an entirely software embodiment, an entirely firmware embodiment, or an embodiment combining software, firmware and hardware aspects. The functionality may be resident in a single computing device, or may be distributed across multiple computing devices/platforms, the multiple computing devices/platforms optionally being connected to one another via one or more networks. Moreover, the structural components described herein may be distributed amongst one or more devices, optionally within a common housing or casing.

Various signals representing content, data, information, or events as described herein may be transferred between a source and a destination in the form of electromagnetic waves traveling through signal-conducting media such as metal wires, optical fibers, and/or wireless transmission media (e.g., air and/or space).

The various methods and acts may be operative across one or more computing servers, databases, and one or more networks. The functionality may be distributed in any manner, or may be located in a single computing device (e.g., a server, a database, a client computer, etc.). As discussed herein, content (e.g., input information (e.g., the identity and characteristics/classifications of the various properties) and calculations based on that input information) may be distributed to intermediary/network components and client-side devices at various times and in various formats. The distribution and transmission techniques described herein may leverage existing components and infrastructure to minimize power dissipation, operational complexity, footprint size, and management involvement, amongst other factors and costs.

The methodological acts and processes described herein may be tied to particular machines or apparatuses. For example, input information regarding a property or a location may be analyzed at a computing device in order to allocate a resource. More generally, one or more computers may include one or more processors and memory storing instructions, that when executed, perform the methodological acts and processes described herein. Furthermore, the methodological acts and processes described herein may perform a variety of functions including transforming an article (e.g., input information identifying a given property and its associated characteristics) into a different state or thing (e.g., an output resource allocation).

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the figures may be performed in other than the recited order, and that one or more steps illustrated may be optional in accordance with aspects of the disclosure.

1. A non-transitory computer readable medium storing instructions that, when executed, configure an apparatus to:
identify a plurality of properties,
obtain a plurality of characteristics associated with each of the properties, the plurality of characteristics comprising a size of the properties, a count of the properties, a classification of the properties, and at least one indication of third party use of the properties,
group the properties into a plurality of groupings based on the obtained characteristics, where each property in a grouping shares a common characteristic with other properties in the grouping,
sum, for each grouping, at least one of: a size associated with the properties in the grouping and a count of the properties in the grouping,
divide, for each grouping, the summation for the grouping by a respective parameter, wherein the parameter is representative of a unit measure of human personnel, to obtain a number of human personnel needed for each grouping, and
sum the number of human personnel needed for each grouping across the plurality of groupings to obtain a total number of human personnel needed,
determine that the total number of human personnel needed is not a whole number,
round down the total number of human personnel needed to obtain a whole number of human personnel needed responsive to determining that the total number of human personnel needed is not a whole number, and
allocate a temporary person in accordance with the difference between the total number of human personnel needed and the whole number of human personnel needed.

2. The non-transitory computer readable medium of claim 1, wherein the common characteristic for each property in a grouping is one of: a critical facility classification, a non-tiered owned or triple net (NNN) leased property classification, a non-tiered gross leased property classification, and a retail and small building property classification.

3. The non-transitory computer readable medium of claim 1, wherein the instructions, when executed, configure the apparatus to:
round up the total number of human personnel needed to obtain a second whole number of human personnel needed responsive to determining that the total number of human personnel needed is not a whole number,
receive an input that indicates that the second whole number of human personnel is desired relative to the whole number of human personnel, and
de-allocating the temporary person responsive to receiving the input that indicates that the second whole number of human personnel is desired relative to the whole number of human personnel.

4. The non-transitory computer readable medium of claim 1, wherein the instructions, when executed, configure the apparatus to:
transmit at least one of the total number of human personnel needed and the whole number of human personnel needed to a client device.

5. An apparatus comprising:
at least one processor; and
memory storing instructions that, when executed by the at least one processor, configure the apparatus to:
identify a plurality of properties,
obtain a plurality of characteristics associated with each of the properties,
group the properties into a plurality of groupings based on the obtained characteristics, where each property in a grouping shares a common characteristic with other properties in the grouping, and
allocate a resource based at least in part on the groupings, the resource comprising human personnel.

6. The apparatus of claim 5, wherein the human personnel comprises a temporary employee.

7. The apparatus of claim 5, wherein the obtained characteristics associated with the properties comprise a classification for each property, where each of the plurality of properties is classified as one of: a critical facility, a non-tiered owned or triple net (NNN) leased property, a non-tiered gross leased property, and a retail and small building property.

8. The apparatus of claim 5, wherein the obtained characteristics associated with each of the properties comprise at least one indication of third party use of the properties.

9. The apparatus of claim 8, wherein the at least one indication of third party use comprises an indication of total area occupied by third parties and a count of third parties present across the plurality of properties.

10. The apparatus of claim 5, wherein the instructions, when executed by the at least one processor, configure the apparatus to:
sum, for each grouping, at least one of: an area associated with the properties in the grouping and a count of the properties in the grouping,
wherein the resource allocation is based at least in part on the summations associated with each of the groupings.

11. The apparatus of claim 10, wherein the instructions, when executed by the at least one processor, configure the apparatus to:
divide, for each grouping, the summation for the grouping by a respective parameter, wherein the parameter is representative of a unit measure of the resource, to obtain a number of units of the resource needed for each grouping, and
sum the number of units of the resource needed for each grouping across the plurality of groupings to obtain the resource allocation.

12. The apparatus of claim 5, wherein the instructions, when executed by the at least one processor, configure the apparatus to:
receive an adjustment to the resource allocation, and
adjust the resource allocation based on the received adjustment.

13. A method comprising:
identifying a plurality of properties,
obtaining a plurality of characteristics associated with each of the properties,
grouping, by a processor, the properties into a plurality of groupings based on the obtained characteristics, where each property in a grouping shares a common characteristic with other properties in the grouping, and
allocating human personnel based at least in part on the groupings.

14. The method of claim 13, wherein the human personnel includes a temporary employee.

15. The method of claim 13, further comprising:
filtering a second plurality of properties in order to obtain the identified plurality of properties.

16. The method of claim 13, wherein the obtained characteristics associated with the properties comprise classifications for the properties, where each of the plurality of properties is classified as one of: a critical facility, a non-tiered owned or triple net (NNN) leased property, a non-tiered gross leased property, and a retail and small building property.

17. The method of claim 13, wherein the obtained characteristics associated with each of the properties comprise at least one indication of third party use of the properties.

18. The method of claim 17, wherein the at least one indication of third party use comprises an indication of total area occupied by third parties and a count of third parties present across the plurality of properties.

19. The method of claim 13, further comprising:
summing, for each grouping, at least one of: an area associated with the properties in the grouping and a count of the properties in the grouping,
wherein the human personnel allocation is based at least in part on the summations associated with each of the groupings.

20. The method of claim 19, further comprising:
dividing, for each grouping, the summation for the grouping by a respective parameter, wherein the parameter is representative of a unit measure of the resource, to obtain a number of persons needed for each grouping, and
summing the number of persons needed for each grouping across the plurality of groupings to obtain the human personnel allocation.
